(19) United States
(12) Patent Application Publication
(10) Pub. No.: US 2026/0341592 A1
(43) Pub. Date: Oct. 29, 2026

(54) PROCESS FOR PRODUCING A RAW MAGNET

(71) Applicant: MIMplus Technologies GmbH & Co. KG, Ispringen (DE)

(72) Inventor: Johannes MAURATH, Bühl (DE)

(21) Appl. No.: 19/121,461

(22) PCT Filed: Nov. 2, 2023
(86) PCT No.: PCT/EP2023/080615

§ 371 Date: Apr. 16, 2025

(30) Foreign Application Priority Data
Nov. 4, 2022 (DE) 102022129227.4

(51) Int. Cl. H01F 41/02; B22F 1/145; B22F 3/10; B33Y 10/00; H01F 1/057

(52) U.S. Cl. CPC H01F 41/0253; B22F 1/145; B22F 3/1021; H01F 1/0571; B22F 2202/05; B22F 2998/10; B33Y 10/00

(57) ABSTRACT

The invention relates to a process for producing a raw magnet, wherein
a magnetic starting material is mixed with a binder, wherein a mixture of the magnetic starting material and the binder is obtained, wherein
a raw form is produced from the mixture, wherein
the raw form is treated with a dispersion including at least one dispersant and one disperse phase, wherein at least one first substance, selected from the dispersant and the disperse phase includes an alloying addition for the raw magnet, wherein a treated raw form is obtained, wherein
the treated raw form is sintered, wherein the raw magnet is obtained.

### CROSS-REFERENCE TO RELATED APPLICATION(S)

This is a national stage application filed under 37 U.S.C. 371 based on International Patent Application No. PCT/EP2023/080615, filed Nov. 2, 2023, which claims priority to German Patent Application No. 102022129227.4 filed Nov. 4, 2022, the entire contents of which are incorporated herein by reference in their entirety.

### TECHNICAL FIELD

The invention relates to a process for producing a raw magnet.

### BACKGROUND

Permanent magnets produced from raw magnets from the group of rare-earths are used in a variety of technical applications and are characterised by a particularly high energy product. In particular, neodymium-iron-boron magnets have an energy product of up to 400 KJ/m³.

In industrial applications in particular, one requirement for permanent magnets is that they have the highest possible coercive field strength. The coercive field strength indicates how strong an oppositely directed magnetic field, to which the permanent magnet is exposed, may be in order to prevent permanent damage to the permanent magnet.

Permanent magnets made of rare-earth elements, in particular neodymium-iron-boron magnets, have a temperature-dependent coercive field strength, wherein the coercive field strength decreases as the temperature rises. Therefore, permanent magnets with a high coercive field strength are preferred for industrial applications, especially for applications in which high temperatures can occur, in particular in electric motors.

One way to increase the coercive field strength is to add at least one additional rare-earth element, in particular at least one ‘heavy’ rare-earth element such as dysprosium and/or terbium. The disadvantage of this is that these elements are very expensive and also reduce the remanence of the permanent magnet.

A second possibility for increasing the coercive field strength in relation to a comparable permanent magnet is to produce a microstructure that is finer-grained than that of the comparable permanent magnet. Such a microstructure can be realised in particular by using a starting powder that is finer-grained than a starting powder of the comparable permanent magnet. The disadvantage of this is that such a fine-grained powder, in particular with a grain size <5 μm, is very difficult to produce and also very difficult to process, especially since the fine-grained powder oxidises easily and thus becomes unusable.

A third possibility for increasing the coercive field strength is a suitable heat treatment, especially for permanent magnets that are produced by sintering. The disadvantage of this is that the coercive field strength can only be increased to a very limited extent.

Furthermore, a grain boundary diffusion process can be used. In this process, sintered raw forms are coated with a dispersion of active substances either directly after the sintering process, after a grinding or wire-cutting process, or after an after-treatment process with acids to remove superficial impurities. These active substances contain at least one heavy rare-earth element, which diffuses along the grain boundaries in the permanent magnet during a subsequent heat treatment process. The disadvantage of this is that the diffusion process is slow and therefore only permanent magnets with a wall thickness of 5 mm or less can be treated economically.

In addition, a powder-blending process can be used. In this process, various powders are mixed together to produce the raw forms for NdFeB permanent magnets. The powders have different proportions of heavy rare-earth elements and different particle sizes. During the sintering of the raw forms, the heavy rare-earth elements accumulate at the grain boundaries. A disadvantage of such powder mixing processes is that the various powders tend to agglomerate due to van der Waals forces and/or magnetic attraction, which is why mixing is challenging and local inhomogeneities can arise. This makes it difficult to make optimal use of the heavy rare-earth elements.

The invention is therefore based on the problem to provide a process for producing a raw magnet, in particular for the production of a permanent magnet, wherein the disadvantages mentioned, in particular with regard to the permanent magnet to be produced, are at least partially eliminated, preferably avoided.

The problem is solved by providing the present technical teaching, in particular the teaching of the independent claims as well as the embodiments disclosed in the dependent claims and the description.

The problem is solved in particular by providing a process for producing a raw magnet, wherein a magnetic starting material is mixed with a binder, wherein a mixture of the magnetic starting material and the binder is obtained. A raw form is then produced from the mixture. Furthermore, the raw form is treated with a dispersion which comprises at least one dispersant and one disperse phase, wherein a treated raw form is obtained. In this case, at least one first substance, selected from the dispersant and the disperse phase, has an alloying addition for the raw magnet. The treated raw form is then sintered, wherein the raw magnet is obtained.

The process advantageously makes it possible to introduce the first substance, in particular the alloying addition, into the raw form in an economical and uniformly distributed manner. The economical introduction of the first substance, in particular the alloying addition, reduces the costs of the raw magnet in the case of expensive and rare alloying additions. In addition, the magnetic properties of the raw magnet, in particular the coercive field strength, are improved and increased in comparison to conventionally manufactured magnets. Furthermore, the process makes it possible to treat raw forms with a wall thickness of up to 40 mm. Advantageously, the first substance, in particular the alloying addition, diffuses into the raw form between particles of the magnetic starting material, in particular along grain boundaries between the particles. In addition, it is advantageously possible for the first substance, in particular the alloying addition, to diffuse into the particles of the magnetic starting material, whereby the coercive field strength also increases, in particular in the case of heavy rare-earth elements as the alloying addition.

In particular, the dispersion consists of the at least one dispersant and the disperse phase.

In particular, the at least one first substance is the alloying addition. In particular, the at least one first substance consists of the alloying addition.

The first substance of the dispersion or the alloying addition is in particular selected from a group consisting of a rare-earth element, in particular a heavy rare-earth element, in particular dysprosium, terbium, holmium, and a light rare-earth element, in particular praseodymium, neodymium, a rare-earth element oxide, a rare-earth element hydride, a rare-earth element nitride, a rare-earth element carbide, a rare-earth element halide, a copper-rare-earth element compound, an aluminium-rare-earth element compound, a zirconium-rare-earth element compound, a gallium-rare-earth element compound, an RₓT_{y}B alloy with a heavy rare-earth element, a dysprosium-cobalt compound, a dysprosium-terbium-cobalt compound, and a terbium-cobalt compound.

The process is advantageously suited for a powder-form magnetic starting material, which is formed on the basis of a newly melted alloy, in particular in the form of a cast ingot or in the form of melt-spun material. Alternatively or additionally, the process is suitable for recycled magnetic material and/or for contaminated recycled magnetic material. In addition, material obtained by recycling is alloyed with at least one rare-earth element, preferably in powder form, to improve its properties.

The magnetic starting material is particularly present in a pure form or in a hydrogenated form. US patent application US 2013/0263699 A1 and German patent DE 198 43 883 C1 describe a process called hydrogen decrepitation (HD) for producing a hydrogenated form of the magnetic starting material by means of hydrogen-induced decomposition.

Preferably, the magnetic starting material is mechanically comminuted, in particular by grinding, to a particle size of 1 μm to 200 μm in order to obtain the powdery magnetic starting material.

Preferably, the magnetic starting material is not partially or not completely dehydrated after grinding and/or before mixing with the binder, but is in a hydrated state. In particular, the magnetic starting material is mixed with the binder in a hydrated state after grinding.

In an embodiment of the process, the mixture has a volume fraction of at least 45% to at most 75% of the magnetic starting material and a volume fraction of at least 25% to at most 55% of the binder. The binder preferably has at least one organic binder component.

In an embodiment, the binder has at least two, in particular at least three, binder components. In particular, a first binder component of the at least two binder components is a base polymer, wherein the base polymer is in particular soluble in a solvent used for predebinding and/or is decomposable by an acid used for predebinding. Furthermore, a second binder component of the at least two binder components is a backbone polymer, wherein the backbone polymer is not soluble or is only very poorly soluble, in particular in the solvent used for predebinding, and/or is not decomposable by the acid used for predebinding. In particular, the backbone polymer has a solubility in the solvent that is less than 1 g/litre. In addition, the backbone polymer does not swell preferentially in the solvent used for predebinding. As a result, the backbone polymer advantageously stabilises the raw form until the raw form is sintered. In particular, the binder comprises, as a third binder component, another base polymer, another backbone polymer and/or a dispersing agent.

In particular, the binder comprises at least one substance selected from a group consisting of polyoxymethylene, polypropylene, paraffin wax, polyethylene and polyamide. Polyoxymethylene, polypropylene, paraffin wax, polyethylene and polyamide are advantageously thermoplastics and are therefore suitable for the production of the raw form. Furthermore, the at least one substance selected from a group consisting of polyoxymethylene, polypropylene, paraffin wax, polyethylene and polyamide facilitates alignment of the particles of the magnetic starting material.

In particular, the binder consists of the at least one substance selected from a group consisting of polyoxymethylene, polypropylene, paraffin wax, polyethylene and polyamide, and the at least one backbone polymer.

In particular, polyethylene, in particular LDPE, is used as the at least one backbone polymer. Alternatively or additionally, a wax, in particular paraffin wax, is used as the base polymer. Alternatively or additionally, a surfactant, in particular stearic acid, is used as dispersant.

In particular, at least one nonpolar organic solvent selected from a group consisting of n-heptane, n-hexane, and cyclohexane is used for predebinding. Alternatively or additionally, at least one polar organic solvent selected from a group consisting of acetone, isopropanol, and ethanol is used for predebinding. Alternatively or additionally, at least one acid selected from a group consisting of nitric acid, acetic acid, and oxalic acid is used for predebinding.

In an embodiment, the binder comprises polyethylene, in particular LDPE, as a backbone polymer, wax, in particular paraffin wax, as a base polymer, and a surfactant, in particular stearic acid, as a dispersant. Furthermore, a non-polar organic solvent, in particular n-heptane, is used for predebinding.

In particular, a colloidal dispersion is used as the dispersion.

In particular, a stable dispersion is used. In the context of the present technical teaching, a stable dispersion is characterised by the disperse phase, in particular the alloying addition for the raw magnet, sedimenting very slowly in the earth's gravitational field, in particular only after at least one hour, or not at all.

In an embodiment, the raw form is treated with the dispersion at least twice, in particular more than twice. Alternatively, the raw form is first treated at least once with a first dispersion and then at least once with a second dispersion, wherein the first dispersion and the second dispersion differ from one another. In particular, the first dispersion has a first alloying addition and the second dispersion has a second alloying addition, wherein the first alloying addition and the second alloying addition differ from one another. Alternatively or additionally, the treated raw form is treated, in particular before sintering, with a further substance, in particular a liquid. In particular, the raw form is treated in a plurality of treatment steps with a plurality of—in particular different—dispersions and/or a plurality of—in particular different—further substances.

In particular, raw forms are produced with a wall thickness of 0.4 mm to at most 10 mm and treated with the dispersion.

In particular, the raw magnet is magnetised by means of a magnetic field, in particular by means of a magnetic pulse, wherein a permanent magnet is obtained. Preferably, the magnetic field, in particular the magnetic pulse, has a magnetic flux density of at least 2 Tesla, particularly preferably at least 3 Tesla. In particular, the process including this step is a process for manufacturing a permanent magnet.

According to a further development of the invention, it is provided that a material which comprises particles of an RₓT_{y}B alloy is used as the magnetic starting material. Preferably, a material which consists of particles of an RₓT_{y}B alloy is used as the magnetic starting material. In particular, a material is preferably used as the magnetic starting material which comprises particles of an NdₓFe_{y}B alloy or consists of particles of an NdₓFe_{y}B alloy.

Preferably, a material is used as the magnetic starting material which has particles of an RₓT_{y}B alloy and particles of a rare-earth-rich phase. In particular, the magnetic starting material preferably consists of a mixture of particles of an RₓT_{y}B alloy and particles of a rare-earth-rich phase. Preferably, a material is used as the magnetic starting material which comprises particles of an NdₓFe_{y}B alloy and particles of a neodymium-rich phase or consists of such particles. In particular, the magnetic starting material preferably comprises a mixture of particles of an NdₓFe_{y}B alloy and particles of a neodymium-rich phase or consists of such a mixture.

In the context of the present technical teaching, R represents a rare-earth element, T represents at least one element selected from a group consisting of iron and cobalt, and B represents the element boron. In particular, the elements iron and cobalt substitute each other partially or completely such that either only iron or only cobalt or any iron-cobalt mixture is present. Preferably, the rare-earth element is neodymium. In a preferred embodiment, the RₓT_{y}B alloy additionally comprises a further element, preferably a metal, in particular a transition metal, selected from a group consisting of aluminium, copper, zirconium, gallium, hafnium, and niobium, preferably in traces. Preferably, the magnetic starting material comprises particles of an Nd₂Fe₁₄B alloy or consists of particles of an Nd₂Fe₁₄B alloy.

Preferably, the rare-earth-rich phase, in particular the neodymium-rich phase, comprises at least one rare-earth element, in particular neodymium, or a chemical compound of this rare-earth element, in particular of neodymium. In addition, the rare-earth-rich phase, in particular the neodymium-rich phase, preferably contains at least one further element of the RₓT_{y}B alloy, in particular of the NdₓFe_{y}B alloy. Alternatively or additionally, the at least one rare-earth element, in particular neodymium, is present in a hydrogenated form. Preferably, the neodymium-rich phase comprises NdH₂ and/or NdH_{2.7} or consists of NdH₂ and/or NdH_{2.7}. Alternatively, in a preferred embodiment, the rare-earth-rich phase, in particular the neodymium-rich phase, consists of at least one rare-earth element, in particular of neodymium, or of a chemical compound of this rare-earth element, in particular of neodymium.

The rare-earth-rich phase preferably forms in the microstructure of the raw magnet and, in particular, in the microstructure of the permanent magnet obtained from the raw magnet, a phase that is located at grain boundaries of the microstructure.

According to a further development of the invention, it is provided that an external magnetic field is applied to the raw form during the production of the raw form. Alternatively or additionally, an external magnetic field is applied to the raw form after the production of the raw form. Advantageously, dipoles of the magnetic starting material are aligned in a parallel orientation by means of the externally applied magnetic field during and/or after the production of the raw form. Preferably, the magnetic field is applied to the raw form before the raw form is treated with the dispersion.

Preferably, the externally applied magnetic field is generated by a switchable electromagnet and/or a permanent magnet.

In an embodiment, the raw form is produced in the externally applied magnetic field. Advantageously, the particles of the magnetic starting material from which the raw form is produced are aligned with the externally applied magnetic field while the raw form is being produced. Preferably, the magnetic starting material of the raw form is hard magnetic. In particular, the external magnetic field is applied to the raw form only during the production of the raw form. In particular, the external magnetic field is not applied to the raw form after the raw form has been manufactured.

In a further embodiment, the external magnetic field is applied to the raw form after the raw form has been manufactured. In particular, the external magnetic field is only applied to the raw form after the raw form has been manufactured. In particular, the external magnetic field is not applied to the raw form during the manufacture of the raw form.

In a further embodiment, the external magnetic field is applied to the raw form during and after the production of the raw form.

Preferably, the raw form is heated to a softening temperature of the mixture while the external magnetic field is applied.

According to a further development of the invention, it is provided that the raw form is predebindered before treatment with the dispersion. Alternatively or additionally, the raw form is predebindered during treatment with the dispersion. Alternatively or additionally, the treated raw form is debindered before sintering. In particular, soluble binder components are removed from the raw form during predebinding, whereby the raw form advantageously has an at least partially open-pored surface, in particular is completely open-pored. In particular, a porosity of the raw form of at least 30 vol %, preferably at least 40 vol %, preferably at least 50 vol %, most preferably at least 55 vol % to at most 60 vol % is obtained. Advantageously, the backbone polymer of the binder remains in the raw form after predebinding. The backbone polymer advantageously increases the mechanical stability of the raw form.

The at least partially open-pored surface and/or the open-pored structure of the raw form advantageously enables a rapid and uniform penetration of the dispersion, in particular of the first substance, in particular the alloying addition, into the raw form. Furthermore, it is advantageously possible for the dispersion, in particular the first substance, in particular the alloying addition, to diffuse freely in the raw form during an optional subsequent heat treatment.

In particular, the predebinding is carried out as a solvent debinding.

If the treatment with the dispersion is carried out after the predebinding, the raw form has an open-pored structure and the dispersion can easily enter the pore channels of the raw form.

If the predebinding is carried out at the same time as the treatment with the dispersion, soluble organic binder components are removed from the raw form, while at the same time the first substance, in particular the alloying addition, diffuses into the pore channels of the raw form.

In a preferred embodiment of the process, the binder is at least partially removed from the raw form by means of a solvent, in particular an organic solvent, in particular by means of a solvent extraction, or by means of a further chemical process. Alternatively or additionally, a residual portion of the binder is removed from the treated raw form by means of thermal decomposition, in particular directly before sintering. Alternatively, a residual portion of the binder is removed from the treated raw form by thermal decomposition during sintering.

In an alternative embodiment, the raw form is treated with the dispersion, in particular coated, before the raw form is predebindered and/or debindered.

According to a further development of the invention, it is provided that the raw form is predebindered for a predetermined period of time, at a predetermined pressure and at a predetermined temperature.

In particular, the predetermined temperature is at least as high as room temperature, in particular 25 °C, in particular, the predetermined temperature is at least 30 °C. Alternatively or additionally, the predetermined temperature is at most such that the predetermined temperature is at least 10 °C less than a boiling temperature of the solvent used in the predebinding at the predetermined pressure.

In particular, the predetermined pressure is at least 50 mbar below ambient pressure up to a maximum of 50 mbar above ambient pressure, preferably the predetermined pressure is almost identical, in particular identical, to ambient pressure.

In particular, the predetermined duration is at least 1 hour up to a maximum of 72 hours.

According to a further development of the invention, it is provided that the treated raw form is dried before sintering.

In an embodiment, the raw form is dried after the first treatment with the dispersion and/or after the treatment with the first dispersion. In particular, the raw form is dried before the raw form is treated a second time with the dispersion and/or with the second dispersion.

In another embodiment, the treated raw form is dried before the treated raw form is treated with the further substance.

According to a further development of the invention, it is provided that a suspension or an aerosol is used as the dispersion. A second substance of the dispersion, selected from the dispersant and the disperse phase, is in particular selected from a group consisting of a solvent, air, nitrogen, argon, and helium. The first substance of the dispersion is selected from a group consisting of a rare-earth element, in particular a heavy rare-earth element, in particular dysprosium, terbium, holmium, and a light rare-earth element, in particular praseodymium, neodymium, an oxide of a rare-earth element, a hydride of a rare-earth element, a nitride of a rare-earth element, a carbide of a rare-earth element, a halide of a rare-earth element, a copper-rare-earth element compound, an aluminium-rare-earth element compound, a zirconium-rare-earth element compound, a gallium-rare-earth element compound, an RₓT_{y}B alloy with a heavy rare-earth element, a dysprosium-cobalt compound, a dysprosium-terbium-cobalt compound, and a terbium-cobalt compound.

If a heavy rare-earth element is used as an alloying addition, in particular as the first substance, the coercive field strength in particular increases because the heavy rare-earth element accumulates at the grain boundary during sintering. Alternatively or additionally, the heavy rare-earth element diffuses into the particles of the magnetic starting material, which also increases the coercive field strength.

If a copper compound, in particular a copper-rare-earth element compound, in particular alloy, or an aluminium compound, in particular an aluminium-rare-earth element compound, in particular alloy, is used as an alloying addition, in particular as the first substance, in particular during sintering, a layer thickness of the rare-earth-rich phase increases and thus, in particular, the coercive field strength increases.

If a zirconium compound, in particular a zirconium-rare-earth element compound, in particular an alloy, is used as an alloying addition, in particular as the first substance, grain growth is advantageously reduced and/or prevented, in particular during sintering.

If a gallium compound, in particular a gallium-rare-earth element compound, in particular an alloy, is used as an alloying addition, in particular as the first substance, the rare-earth-rich phase, in particular after sintering, has an amorphous structure, whereby the coercive field strength is advantageously increased.

According to a further development of the invention, it is provided that a compound selected from a group consisting of cyclohexane, n-hexane, n-heptane, paraffin oil, acetone, isopropanol, ethanol, and an organic solvent is used as the solvent.

In particular, a non-polar, in particular organic solvent is used as the solvent.

According to a further development of the invention, it is provided that the dispersion comprises the first substance as particles with a particle size of at least 0.001 μm to at most 30 μm. Alternatively or additionally, a volume fraction of the first substance in the dispersion is at least 1% to at most 70%.

In particular, the first substance is present at the beginning of the process in particle form with a particle size of at least 0.001 μm to at most 30 μm. Alternatively, the first substance is processed by means of a grinding process, in particular as a sub-step of the process, to produce the particles with a particle size of at least 0.001 μm to at most 30 μm. Preferably, the grinding process is carried out by means of a device selected from a group consisting of an attritor mill, a jet mill and a ball mill.

According to a further development of the invention, it is provided that the raw form is treated with the dispersion by means of a process selected from a group consisting of spraying, in particular by means of a spray gun, brushing, in particular by means of a brush and/or a roller, dipping, printing, in particular pad printing and/or screen printing, and slot-die coating. Advantageously, the raw form, in particular the predebindered and thus in particular the open-pored raw form, is infiltrated with the dispersion.

In an embodiment, the raw form is immersed in the dispersion such that the raw form is completely surrounded by the dispersion. In particular, the dispersion comprises the alloying addition and a solvent. In particular, the dispersion consists of the alloying addition and a solvent. In particular, the raw form is immersed in the dispersion for a period of at least 1 second and at most 24 hours, in particular enveloped by the dispersion.

In a further embodiment, the raw form is coated with the dispersion, in particular an entire surface of the raw form is coated with the dispersion. In particular, the raw form is sprayed and/or coated with the dispersion. In particular, the dispersion comprises the alloying addition and at least one gas selected from a group consisting of air and an inert gas, in particular nitrogen, argon and helium. In particular, the dispersion consists of the alloying addition and at least one gas selected from a group consisting of air and an inert gas, in particular nitrogen, argon and helium. In particular, the raw form is sprayed with the dispersion for a period of at least 1 second and at most 30 seconds.

According to a further development of the invention, it is provided that the raw form is produced by means of a process selected from a group consisting of injection moulding, in particular metal powder injection moulding, additive manufacturing, extrusion, and wet pressing.

In an embodiment of the process, the raw form is produced by injection moulding a mixture comprising the magnetic starting material and the binder, which is in particular organic. Alternatively, the raw form is produced by injection moulding a mixture consisting of the magnetic starting material and the binder, which is in particular organic.

In a further embodiment of the process, the raw form is produced by wet pressing a magnetic starting material. In the case of wet pressing, an organic solvent, preferably a volatile non-polar and/or polar organic solvent, is used as a binder. The volatile non-polar and/or polar organic solvent is selected from a group consisting of an alcohol, an acyclic alkane, a cyclic alkane, a ketone, and a mixture of volatile organic substances that can serve as solvents. Ethanol or isopropanol is preferably used as the alcohol. Cyclohexane is preferably used as the cyclic alkane.

As ketone, acetone is preferably used. The mixture of volatile organic substances is preferably selected from a group consisting of petroleum, white spirit, and Ligroin. Furthermore, the raw form is preferably dried before sintering.

According to a further development of the invention, it is provided that the treated raw form is sintered in a vacuum. Alternatively, the treated raw form is sintered in an atmosphere that comprises at least one process gas selected from a group consisting of argon and helium. Alternatively, the treated raw form is sintered in an atmosphere that consists of at least one process gas selected from a group consisting of argon and helium. Advantageously, during sintering, the particles of the magnetic starting material, in particular the RₓT_{y}B particles, are alloyed with the alloying addition, and the magnetic properties of the raw magnet, in particular the coercive field strength, consequently increase.

In the context of the present technical teaching, a vacuum is understood to be an atmosphere that has a pressure lower than 1.10-3 mbar absolute.

In particular, the raw form is sintered in a helium atmosphere. Alternatively, the raw form is sintered in an argon atmosphere. Alternatively, the raw form is sintered in an argon-helium atmosphere. In particular, the atmosphere, selected from the helium atmosphere, the argon atmosphere and the argon-helium atmosphere, has a pressure of at least 1.10-3 mbar to at most 200 mbar above ambient pressure. In the context of the present technical teaching, a helium atmosphere is understood to be, in particular, a gas consisting of pure helium and impurities of at most 5 vol %.

In the context of the present technical teaching, an argon atmosphere is understood to be, in particular, a gas that consists of pure argon and impurities of at most 5 vol %.

In the context of the present technical teaching, an argon-helium atmosphere is understood to be, in particular, a gas that consists of pure argon, pure helium and impurities of at most 5 vol %.

In particular, the raw form is sintered at a sintering temperature of at least 950 °C to at most 1200 °C, preferably from at least 1000 °C to at most 1100 °C.

In an embodiment, during sintering, the treated raw form is heated from room temperature or a debinding temperature to the sintering temperature at a heating rate of at least 0.1 K/min to at most 10 K/min. During the heating of the treated raw form, a holding stage is preferably provided at at least one predetermined intermediate temperature; in particular, holding stages are incorporated at a plurality of predetermined intermediate temperatures, wherein the temperature is kept constant for a predetermined period of time, preferably from at least 30 minutes to at most 1200 minutes, at the at least one holding stage. In particular, the at least one intermediate temperature is from at least 450 °C to at most 900 °C, preferably from at least 700 °C to at most 800 °C. Advantageously, in the at least one holding stage, the particles of the magnetic starting material, in particular the RₓT_{y}B particles, are pre-alloyed with the alloying addition. In an embodiment of the process, the holding stages improve the diffusion of the alloying addition along the grain boundaries or the surface of the magnetic starting material into the interior of the raw form.

The invention also includes a raw magnet-in particular a permanent magnet obtained after magnetisation of the raw magnet-which is produced by means of a process according to the invention or by means of a process according to one or more of the embodiments described above. The invention further includes use of such a permanent magnet in a device selected from a group consisting of an electric motor, a loudspeaker, a microphone, a generator, a hard disk drive, and a sensor.

The invention also includes a device selected from a group consisting of an electric motor, a loudspeaker, a microphone, a generator, a hard disk drive, and a sensor, wherein the device comprises a permanent magnet provided by a process according to the invention or a process according to one or more of the previously described embodiments.

### BRIEF DESCRIPTION OF DRAWINGS

The invention is explained in more detail below on the basis of the drawings. The following show:

FIG. 1 a flow chart of an embodiment of a process for producing a raw magnet, and

FIGS. 2a-2e a schematic representation of the embodiment for producing the raw magnet.

### DETAILED DESCRIPTION

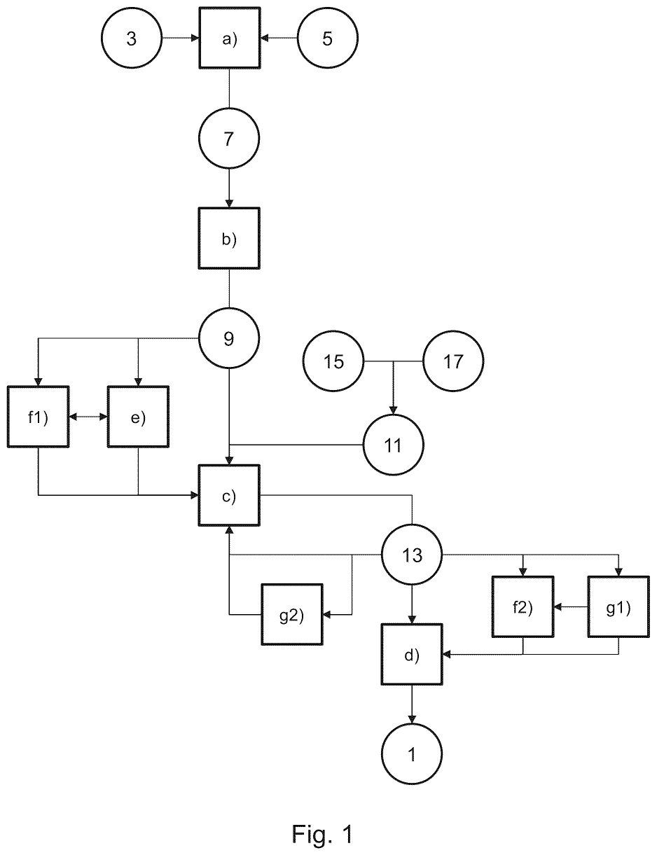

FIG. 1 shows a flow chart of an embodiment of a process for producing a raw magnet 1.

In a first step a), a magnetic starting material 3 is mixed with a binder 5, wherein a mixture 7 of the magnetic starting material 3 and the binder 5 is obtained.

In particular, a material is used as the magnetic starting material 3 which comprises particles of an RxTyB alloy. Alternatively, a material which consists of particles of an RₓT_{y}B alloy is used as magnetic starting material 3. Alternatively, a material which has particles of an NdₓFe_{y}B alloy or consists of particles of an NdₓFe_{y}B alloy is used as magnetic starting material 3.

Preferably, the mixture 7 has a volume fraction of at least 40% to at most 75% of the magnetic starting material 3 and a volume fraction of at least 25% to at most 55% of the binder 5. The binder 5 preferably has at least one organic binder component.

In a second step b), a raw form 9 is produced from the mixture 7. In particular, the raw form 9 is produced by means of a process selected from a group consisting of injection moulding, in particular metal powder injection moulding, additive manufacturing, extrusion and wet pressing. In particular, an external magnetic field is applied to the raw form 9 in the second step b), in particular during the production of the raw form 9.

In a third step c), the raw form 9 is treated with a dispersion 11, which has at least one dispersant and one disperse phase, wherein a treated raw form 13 is obtained. Alternatively, in the third step c), the raw form 9 is treated with a dispersion 11, which consists of at least one dispersant and the disperse phase, wherein the treated raw form 13 is obtained.

In this process, at least a first substance 15, selected from the dispersant and the disperse phase, has an alloying addition for the raw magnet 1. In particular, the at least one first substance 15, selected from the dispersant and the disperse phase, consists of the alloying addition.

In particular, in step c), the raw form 9 is treated with the dispersion 11 by a process selected from a group consisting of spraying, in particular by means of a spray gun, brushing, in particular by means of a brush and/or a roller, dipping, printing, in particular pad printing and/or screen printing, and slot-die coating.

In particular, a colloidal and/or stable dispersion is used as dispersion 11.

In particular, a suspension or an aerosol is used as dispersion 11.

In particular, the first substance 15 of the dispersion 11 is selected from a group consisting of a rare-earth element, in particular a heavy rare-earth element, in particular dysprosium, terbium, holmium, and a light rare-earth element, in particular praseodymium, neodymium, an oxide of a rare-earth element, a hydride of a rare-earth element, a nitride of a rare-earth element, a carbide of a rare-earth element, a halide of a rare-earth element, a copper-rare-earth element compound, an aluminium-rare-earth element compound, a zirconium rare-earth element compound, a gallium rare-earth element compound, a RₓT_{y}B alloy with a heavy rare-earth element, a dysprosium-cobalt compound, a dysprosium-terbium-cobalt compound, and a terbium-cobalt compound. Alternatively or additionally, the dispersion 11 comprises the first substance 15 as particles having a particle size of at least 0.001 μm to at most 30 μm. Alternatively or additionally, a volume fraction of the first substance 15 in the dispersion 11 is at least 1% to at most 70%.

In particular, a second substance 17 of the dispersion 11, selected from the dispersant and the disperse phase, is selected from a group consisting of a solvent, air, nitrogen, argon, and helium. In particular, a compound selected from a group consisting of cyclohexane, n-hexane, n-heptane, paraffin oil, acetone, isopropanol, ethanol, and an organic solvent is used as a solvent.

In particular, the raw form 9 is predebindered in the third step c), in particular during the treatment with the dispersion 11. In particular, the raw form 9 is predebindered for a predetermined duration, at a predetermined pressure and at a predetermined temperature.

Optionally, the third step c) is carried out at least twice, in particular multiple times. In this way, the raw form 9 is treated at least twice, in particular a plurality of times, with the dispersion 11 and/or with mutually different dispersions 11, in particular a first dispersion and a second dispersion. In particular, the first dispersion has a first first substance and the second dispersion has a second first substance, wherein the first first substance and the second first substance are different.

In a fourth step d) the treated raw form 13 is sintered, wherein the raw magnet 1 is obtained. In particular, the treated raw form 13 is sintered in a vacuum. Alternatively, the treated raw form 13 is sintered in an atmosphere comprising at least one process gas selected from a group consisting of argon and helium.

In an optional manufacturing step carried out after the fourth step d), the raw magnet is magnetised by means of a magnetic field, in particular by means of a magnetic pulse, wherein a permanent magnet is obtained. Preferably, the magnetic field, in particular the magnetic pulse, has a magnetic flux density of at least 2 Tesla, particularly preferably at least 3 Tesla.

In an optional fifth step e), after the second step b), in particular after the production of the raw form 9, and before the third step c), in particular before the treatment of the raw form 9 with the dispersion 11, an external magnetic field is applied to the raw form 9.

In an optional first sixth step f1), the raw form 9 is predebindered after the second step b), in particular after the production of the raw form 9, and before the third step c), in particular before the treatment with the dispersion 11.

Preferably, the first sixth step f1) is carried out after the fifth step e). However, it is also possible to carry out the first sixth step f1) before or at the same time as the fifth step e).

In an optional second sixth step f2), the treated raw form 13 is debinded, in particular thermally debinded, before the fourth step d), in particular before sintering.

In an optional first seventh step g1), the treated raw form 13 is dried before the fourth step d), in particular before sintering.

In an optional second seventh step g2), the treated raw form 13 is dried before a renewed third step c), in particular before a renewed treatment with the dispersion 11 and/or a treatment with a further dispersion 11.

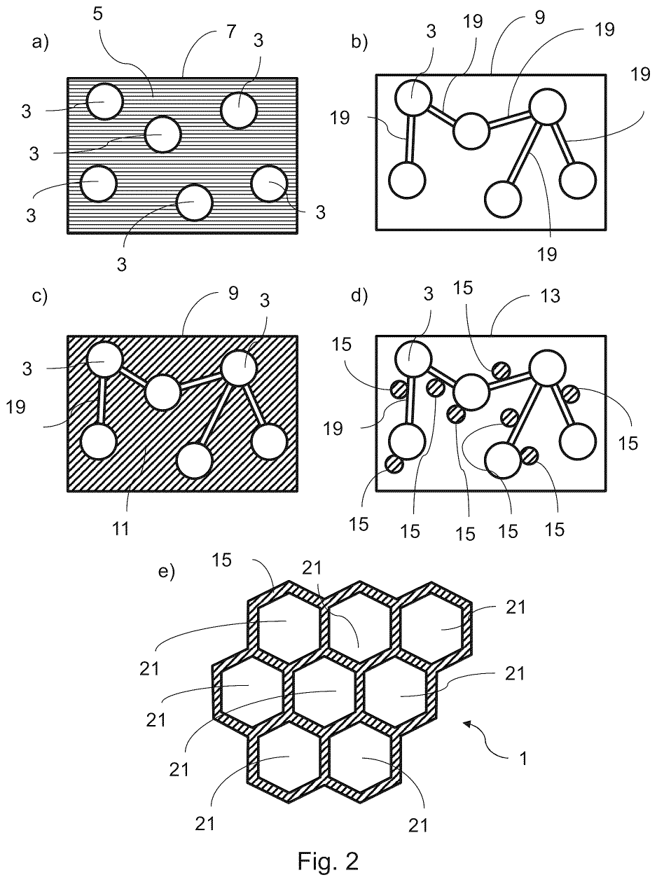

FIG. 2 shows a schematic representation of the embodiment for producing the raw magnet 1. Identical elements and elements with identical functions are provided with the same reference signs in all figures, so that reference is made to the previous description in each case.

FIG. 2 a) shows the mixture 7 of the magnetic starting material 3, preferably of an RₓT_{y}B alloy, in particular of an NdₓFe_{y}B alloy, and the binder 5, which is in particular organic. The mixture 7 is used to produce the raw form 9 by means of a process, preferably selected from a group consisting of injection moulding, additive manufacturing, extrusion and wet pressing.

FIG. 2 b) shows the raw form 9 after predebinding, in particular after at least partial removal of the organic binder 5. In particular, during predebinding, soluble binder components of the binder 5 are dissolved out of the raw form 9, whereby the raw form 9 has an at least partially open-pored surface, in particular is completely open-pored. In particular, after predebinding, a backbone polymer 19 of the binder 5 remains in the raw form 9.

For a clearer representation, only one particle of the magnetic starting material 3 is provided with a reference symbol.

FIG. 2 c) shows the raw form 9 during treatment with the dispersion 11. In particular, the raw form 9 in FIG. 2 c) is infiltrated with the dispersion 11, so that the dispersion 11 penetrates into the pores of the raw form 9.

For a clearer representation, only one particle of the magnetic starting material 3 and only one backbone polymer 19 are provided with a reference symbol.

FIG. 2 d) shows the treated raw form 13, in particular after drying of the treated raw form 13. The first substance 15 is embedded in particle form between the particles of the magnetic starting material 3 and the backbone polymer 19.

FIG. 2 e) shows the raw magnet 1 after sintering. The particles of the magnetic starting material 3 combine to form grains 21, in particular RxTyB grains. The grains 21 are each enclosed by the first substance 15.

1. Process for producing a raw magnet wherein
a magnetic starting material is mixed with a binder, wherein a mixture of the magnetic starting material and the binder is obtained, wherein
a raw form is produced from the mixture, wherein
the raw form is treated with a dispersion including at least one dispersant and one disperse phase, wherein at least one first substance, selected from the dispersant and the disperse phase, includes an alloying addition for the raw magnet, wherein a treated raw form is obtained, wherein
the treated raw form is sintered, wherein the raw magnet is obtained.

2. Process according to claim 1, wherein a material is used as the magnetic starting material which comprises particles of an RₓT_{y}B alloy and preferably particles of a rare-earth-rich phase.

3. Process according to claim 1, wherein an external magnetic field is applied to the raw form during and/or after the production of the raw form.

4. Process according claim 1, wherein
the raw form is predebindered before and/or during the treatment with the dispersion, and/or
the treated raw form is debindered before sintering.

5. Process according to claim 1, wherein the raw form is predebindered for a predetermined period, at a predetermined pressure and at a predetermined temperature.

6. Process according to claim 1, wherein the treated raw form is dried before sintering.

7. Process according to claim 1, wherein
a suspension or an aerosol is used as dispersion wherein
a second substance of the dispersion, selected from the dispersant and the disperse phase, is selected from a group consisting of a solvent, air, nitrogen, argon, and helium, wherein
the first substance is selected from a group consisting of a rare-earth element, in particular a heavy rare-earth element, in particular dysprosium, terbium, holmium, and a light rare-earth element, in particular praseodymium, neodymium, an oxide of a rare-earth element, a hydride of a rare-earth element, a nitride of a rare-earth element, a carbide of a rare-earth element, a halide of a rare-earth element, a copper-rare-earth element compound, an aluminium-rare-earth element compound, a zirconium rare-earth element compound, a gallium rare-earth element compound, a RₓT_{y}B alloy with a heavy rare-earth element, a dysprosium-cobalt compound, a dysprosium-terbium-cobalt compound, and a terbium-cobalt compound.

8. Process according to claim 1, wherein a compound selected from a group consisting of cyclohexane, n-hexane, n-heptane, paraffin oil, acetone, isopropanol, ethanol, and an organic solvent is used as a solvent.

9. Process according to claim 1, wherein
the dispersion comprises the first substance as particles having a particle size of at least 0.001 um to at most 30 μm, and/or
a volume fraction of the first substance in the dispersion is at least 1% to at most 70%.

10. Process according claim 1, wherein the raw form is treated with the dispersion by a process selected from a group consisting of spraying, in particular by means of a spray gun, brushing, in particular by means of a brush and/or a roller, dipping, printing, in particular pad printing and/or screen printing, and slot-die coating.

11. Process according to-any claims claim 1, wherein the raw form is produced by means of a process selected from a group consisting of injection moulding, additive manufacturing, extrusion, and wet pressing.

12. Process according to claim 1, wherein the treated raw form is sintered in vacuum or in an atmosphere comprising at least one process gas selected from a group consisting of argon and helium.
